(19) United States
(12) Patent Application Publication
(10) Pub. No.: US 2020/0267469 A1
(43) Pub. Date: Aug. 20, 2020

(54) COMPOSITE HEADSET

(71) Applicant: ARIMA ACOUSTIC ENGINEERING CORPORATION, NEW TAIPE CITY (TW)

(72) Inventors: Yue-Shih Jeng, Hsinchu County (TW); CHUNG-YANG LIN, New Taipei City (TW); LAN-CHUNG CHI, Hsinchu County (TW)

(21) Appl. No.: 16/794,296

(22) Filed: Feb. 19, 2020

(30) Foreign Application Priority Data
Feb. 19, 2019 (TW) 108105438
Feb. 19, 2019 (TW) 108105442

(51) Int. Cl. H04R 1/24; H04R 1/10; H04R 9/06; H04R 17/00; H04R 23/02

(52) U.S. Cl. CPC H04R 1/24; H04R 1/1008; H04R 23/02; H04R 9/06; H04R 17/00; H04R 1/1075

(57) ABSTRACT

A composite headset is provided, including: two sound production modules, where the two sound production modules can be worn on both sides of the head of a user, and each of the sound production modules includes a moving-coil unit and a thin-film sound production element. The moving-coil unit is used to produce a first-frequency sound field, and the thin-film sound production element is used to produce a second-frequency sound field. The thin-film sound production element is an arc-shaped convex or concave sheet that is formed by being bent towards a sound output direction of the moving-coil unit.

### CROSS-REFERENCE TO RELATED PATENT APPLICATION

This application claims the benefit of priority to Taiwan Patent Application No. 108105438 and No. 108105442, filed on Feb. 19, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a composite headset, and more particularly to a composite headset provided with a multi-frequency sound production element.

### BACKGROUND OF THE DISCLOSURE

With the popularity of electronic sports games in recent years, there is an increasingly high requirement for the quality of computer peripherals used for electronic sports. A headset is the most prominent among those electronic sports peripherals. The electronic sports headset not only can enable a user to listen to the game background music or sound, but more importantly, it can produce an ambient sound effect to let the user deeply engage with the game. Moreover, the user can listen with the headset and make judgment to identify the positions of opponents or various targets. For example, in a first-person shooting game, a user can identify the positions of approaching teammates or enemies according to the sound of their footsteps, or identify a crossfire position in the game according to the sound direction of gunfire, explosion, or the like.

Therefore, it is particularly important for the electronic sports headset to output desired sound details and shape a sense of space in the ambient sound field, so that the user can make judgment from the sound details or the ambient space regarding the game sound effect, thus improving user experience in the game.

However, the conventional headset has an undesired sound effect at high frequencies, therefore the output sound details are unsatisfactory, and as a result, the sense of space in the ambient sound field is degraded. For these reasons, the conventional headset has many shortcomings in use. Therefore, how to make structural improvements to solve the foregoing problems has become one of major subjects to be dealt with in the field.

### SUMMARY OF THE DISCLOSURE

The main objective of the present disclosure is to overcome the shortcomings of the conventional headset which outputs an undesired sound effect at high frequencies and fails to shape a sense of space.

In one aspect, the present disclosure provides a composite headset, which includes two sound production modules. The two sound production modules can be worn on both sides of the head of a user, and each includes a moving-coil unit and a thin-film sound production element, wherein the moving-coil unit is used to produce a first-frequency sound field, the thin-film sound production element is used to produce a second-frequency sound field, and the thin-film sound production element is an arc-shaped convex or concave sheet that is formed by being bent towards a sound output direction of the moving-coil unit.

In a preferred embodiment of the present disclosure, the thin-film sound production element is provided with a piezoelectric thin film and two conductive layers; the two conductive layers are respectively attached to two opposite sides of the piezoelectric thin film, and are electrically connected to a sound source signal, so that a voltage of the sound source signal is transmitted to the two conductive layers to make the piezoelectric thin film vibrate under an inverse piezoelectric effect, so as to produce sound.

One of the advantages of the present disclosure is that the present disclosure can improve on sound details at a high audio frequency by using a thin-film sound production element, and can produce rich sound levels and strengthen the sense of space by a structural design and spatial arrangement of the thin-film sound production element.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a composite headset of the present disclosure;

FIG. 2 is a schematic sectional view of a sound production module in a first embodiment of a composite headset of the present disclosure;

FIG. 3 is a schematic planar view of the sound production module in the first embodiment of the composite headset of the present disclosure;

FIG. 4 is schematic view of a circuit of the sound production module used in the composite headset of the present disclosure;

FIG. 5 is a schematic sectional view of a thin-film sound production element used in the present disclosure;

FIG. 6 is a schematic sectional view of a sound production module in a second embodiment of a composite headset of the present disclosure;

FIG. 7 is a schematic planar view of the sound production module in the second embodiment of the composite headset of the present disclosure;

FIG. 8 is a schematic sectional view of a sound production module in a third embodiment of a composite headset of the present disclosure;

FIG. 9 is a schematic sectional view of a sound production module in a fourth embodiment of a composite headset of the present disclosure;

FIG. 10 is a schematic sectional view of a sound production module in a fifth embodiment of a composite headset of the present disclosure;

FIG. 11 is a schematic sectional view of a sound production module in a sixth embodiment of a composite headset of the present disclosure; and

FIG. 12 is a curve chart showing frequency response characteristics in a specific embodiment of a composite headset of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

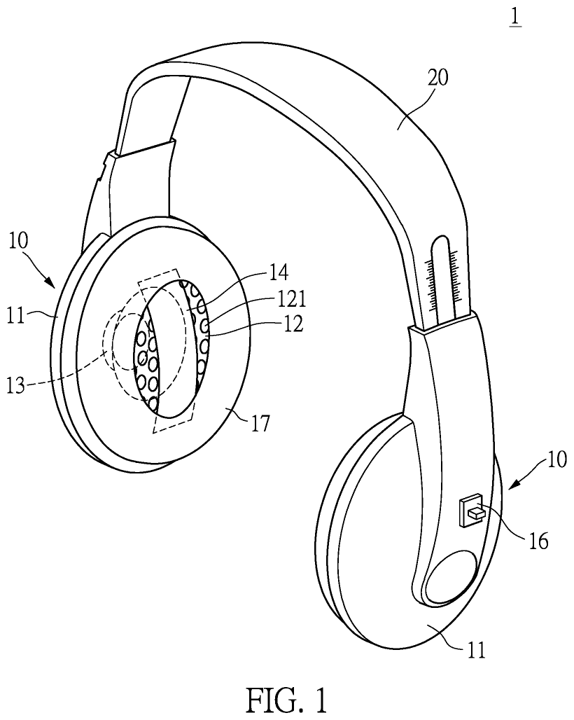

As shown from FIG. 1 to FIG. 5, the present disclosure provides a composite headset 1 which has two sound production modules 10. The two sound production modules 10 are respectively disposed on the two sides of a wearable unit 20. The wearable unit 20 can be worn on the head of a user, and enables the two sound production modules 10 to be worn on both sides of the head of the user.

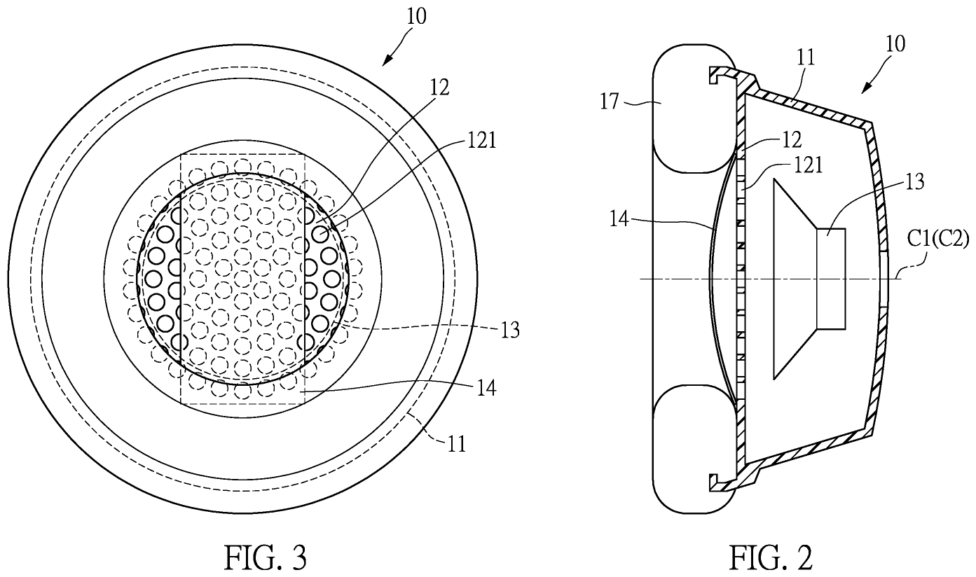

As shown in FIGS. 2 and 3, the two sound production modules 10 each include a casing 11, a moving-coil unit 13, and a thin-film sound production element 14. A side of the casing 11 that faces the head of the user is provided with a sound output surface 12, and a plurality of sound apertures 121 is provided in the sound output surface 12. Each casing 11 is provided with an ear shield 17 at the outer side of the sound output surface 12, where the ear shield is used to contact the ear of the user. The moving-coil unit 13 is accommodated inside the casing 11 and disposed at a side of the sound output surface 12 that faces away from the head of the user. A sound field produced by the moving-coil unit 13 can pass through the plurality of sound apertures 121 to be output out of the sound output surface 12.

The thin-film sound production element 14 is formed by bending a rectangular sheet into an arc-shaped convex sheet that is curved in the middle towards a sound output direction of the moving-coil unit 13. As shown in FIG. 3, in this embodiment, two ends of the thin-film sound production element 14 are disposed on the sound output surface 12, while the middle convex portion of the thin-film sound production element 14 keeps a distance from the sound output surface 12. Therefore, the thin-film sound production element 14 is designed into the arc-shaped convex sheet that is curved in the middle towards the sound output direction of the moving-coil unit 13, and thus is unlikely to close the plurality of sound apertures 121 in the sound output surface 12, so that sound output by the moving-coil unit 13 can pass through an interval between the thin-film sound production element 14 and the sound output surface 12.

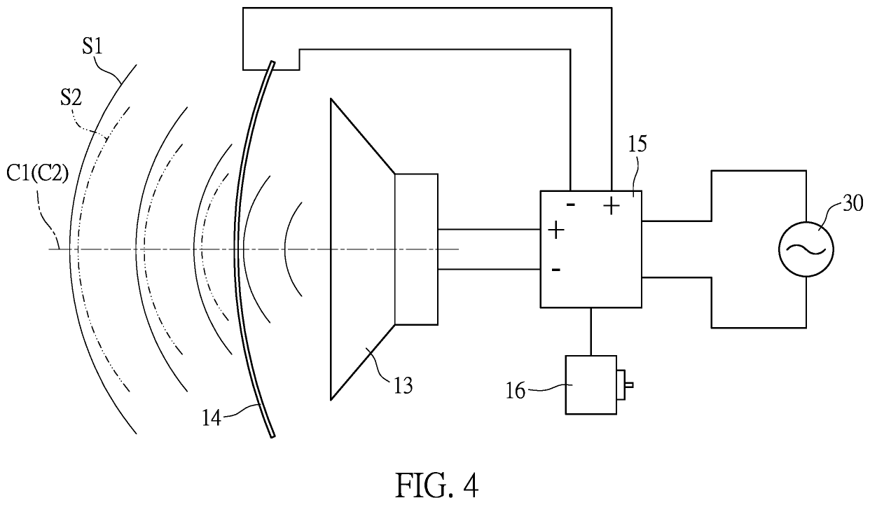

FIG. 4 is a schematic view of a control circuit used in the composite headset 1 of the present disclosure. In the circuit, the moving-coil unit 13 and the thin-film sound production element 14 are connected to a control unit 15, and the control unit 15 is connected to a sound source signal 30. The control unit 15 splits a sound signal output by the sound source signal 30 into a first audio frequency signal and a second audio frequency signal, then outputs the first audio frequency signal to the moving-coil unit 13 to produce a first-frequency sound field S1, and outputs the second audio frequency signal to the thin-film sound production element 14 to produce a second-frequency sound field S2. In this embodiment, a central axial line C2 of the second-frequency sound field output by the thin-film sound production element 14 is parallel to and aligned with a central axial line C1 of the first-frequency sound field output by the moving-coil unit 13. Thus, the first-frequency sound field S1 and the second-frequency sound field S2 are output along the same direction with the same axis.

Particularly, the first-frequency sound field S1 and the second-frequency sound field S2 respectively cover different audio frequency ranges. Moreover, in this embodiment, because the moving-coil unit 13 and the thin-film sound production element 14 have different audio characteristics, the first-frequency sound field S1 covers a low-to-middle frequency range, while the second-frequency sound field S2 covers a middle-to-high frequency range.

In addition, in this embodiment, the control unit 15 can be further connected to a control switch 16 which is used by the user to input a control signal to control a sound field output mode of the sound production module 10. For example, the control switch 16 can control the sound production module 10 to operate in a first audio frequency mode or a second audio frequency mode. When the sound production module 10 operates in the first audio frequency mode, the control unit 15 outputs a first audio frequency signal and a second audio frequency signal simultaneously to the thin-film sound production element 14 and the moving-coil unit 13. Thus, the thin-film sound production element 14 and the moving-coil unit 13 simultaneously output a first-frequency sound field S1 and a second-frequency sound field S2 which are then integrated to form a composite sound field. When the sound production module 10 operates in the second audio frequency mode, the control unit 15 outputs the sound signal merely to the moving-coil unit 13, and merely produces the first-frequency sound field S1 via the moving-coil unit 13. Therefore, the composite headset 1 of the present disclosure can output the sound field in the most suitable mode by adjustment according to its use purpose.

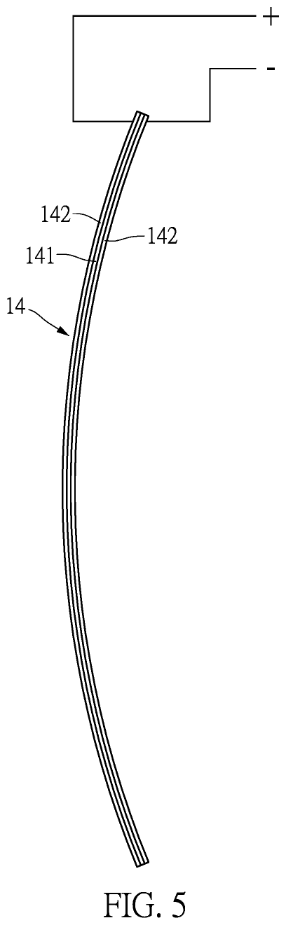

The thin-film sound production element 14 used in the present disclosure is a piezoelectric thin-film sound production element. As shown in FIG. 5, the thin-film sound production element 14 is provided with a piezoelectric thin film 141. The piezoelectric thin film 141 has an upper side and a lower side that are opposite of each other, and a conductive layer 142 is provided on the upper side and the lower side of the piezoelectric thin film 141 separately. The piezoelectric thin film 141 is a thin film or sheet bar made from a high-polymer material with a piezoelectric property, preferably from polyvinylidene fluoride (PVDF); or the piezoelectric thin film is made from another polymer material capable of achieving a piezoelectric effect, such as nylon, polyester, polyvinyl chloride, or the like. The piezoelectric thin film 141 has a thickness preferably below 0.3 mm. The two conductive layers 142 are respectively provided on the upper and lower sides of the piezoelectric thin film 141 by means of evaporation, sputtering, deposition, electroplating, chemical plating, printing, or coating; and the two conductive layers 142 roughly take up most of the areas of the upper and lower sides of the piezoelectric thin film 141 respectively. Moreover, the two conductive layers 142 directly contact the upper and lower surfaces of the piezoelectric thin film 141 and there is no interval therebetween. The two conductive layers 142 may be conductive metal layers made from one or a combination of, for example, copper (Cu), silver (Ag), chromium (Cr), nickel (Ni), and titanium (Ti). Alternatively, the conductive layers 142 may be conductive metal oxide thin films made from one or a combination of titanium nitride (TiN), stannic oxide (SnO₂), indium oxide (In₂O₃), zinc oxide (ZnO), and indium tin oxide (ITO).

The conductive layer 142 is attached to both sides of the thin-film sound production element 14. After a voltage of the sound source signal is input to the two conductive layers 142, a positive electric field and a negative electric field are respectively formed on the two sides of the piezoelectric thin film 141, so that the piezoelectric thin film 141 vibrates under an inverse piezoelectric effect. In this way, the sound source signal is converted into a sound signal by means of the vibration of the piezoelectric thin film 141.

The thin-film sound production element 14 used in the present disclosure is characterized in that most of the areas of the upper and lower sides of the piezoelectric thin film 141 are covered by the conductive layer 142. After the voltage of the sound source signal 30 is input to the two conductive layers 142, most of the areas of the piezoelectric thin film 141 vibrate together to form a large-area vibrating sound-production region, thus enhancing the strength of the sound field output by the thin-film sound production element 14 of the present disclosure. In addition, the piezoelectric thin film 141 has a limited thickness that is below 0.3 mm, and therefore is extremely light. Moreover, the piezoelectric thin film 141 is made from a material with an ideal piezoelectric property. Therefore, the thin-film sound production element 14 of the present disclosure has a desired response characteristic to a high-frequency signal, improving sound quality of the high-frequency signal.

Furthermore, as shown in FIG. 3 and FIG. 4, because the thin-film sound production element 14 of the present disclosure is designed into an arc-shaped convex sheet that is curved towards a sound output direction of the moving-coil unit 13, the second-frequency sound field S2 is diffused along the normal to the curved surface of the thin-film sound production element 14. Moreover, when the thin-film sound production element 14 produces sound, the sounds from different distances from different positions on the curved line of the thin-film sound production element 14 to the ears of the user are different. Therefore, by the foregoing design, the thin-film sound production element 14 of the present disclosure produces a diffuse sound field of a wide range, and time required for transmitting the sound from the different positions on the thin-film sound production element 14 to the ears of the user varies as the distances therebetween are different. Therefore, the thin-film sound production element 14 of the present disclosure can produce a sound field that shapes a sense of space and has rich sound levels.

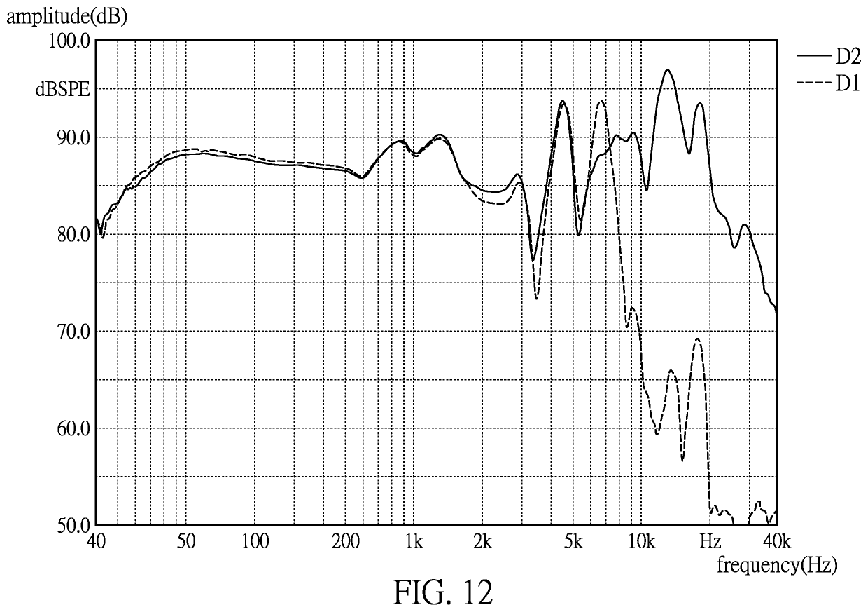

FIG. 12 is a curve chart showing frequency response characteristics in an embodiment of the composite headset 1 of the present disclosure. As shown in FIG. 12, the moving-coil unit 13 has a desired response characteristic in a medium-low frequency range, while the thin-film sound production element 14 has a desired response characteristic in a medium-high frequency range. A response curve D1 shows response characteristics of the moving-coil unit 13 to sound signals at different frequencies, and a response curve D2 shows response characteristics of the thin-film sound production element 14 to sound signals at different frequencies. In this embodiment, the response curve D1 shows that the moving-coil unit 13 has a desired response characteristic at frequencies below 5 KHz, but its response characteristic dramatically degrades at frequencies above 5 KHz. The response curve D2 shows that the thin-film sound production element 14 maintains a desired response characteristic in a frequency range from 5 KHz to 40 KHz. Therefore, the composite headset 1 of the present disclosure can improve on the quality of a sound signal by using the thin-film sound production element 14.

The upper limit of high audio frequencies that human ears can detect is 20 KHz. The thin-film sound production element 14 of the present disclosure can extend the response frequency of the headset beyond the high frequency range detectable to human ears. Moreover, because the thin-film sound production element 14 of the present disclosure is designed into an arc-shaped structure with a curved surface, the composite headset 1 of the present disclosure can easily produce a sound field that shapes a sense of space and has rich sound levels.

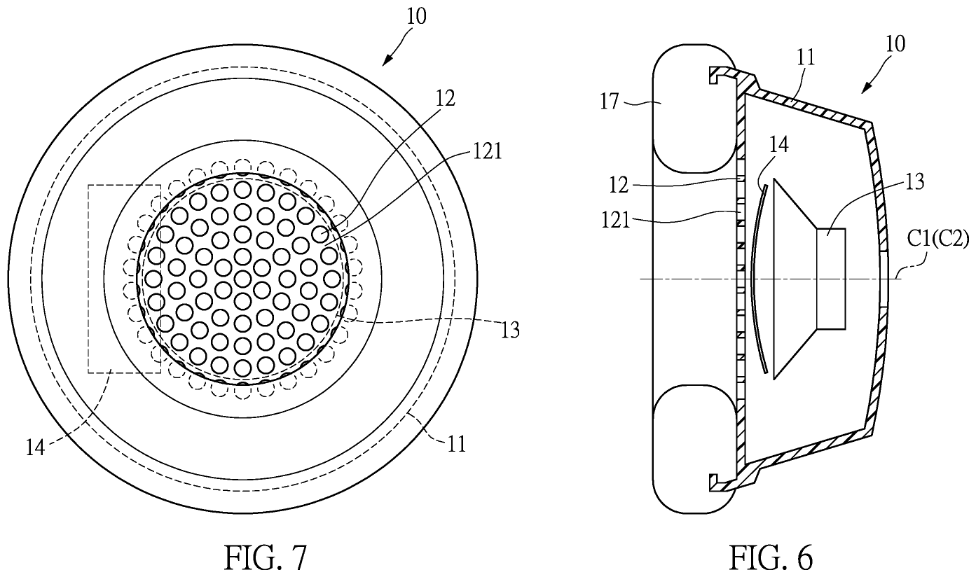

FIG. 6 and FIG. 7 show a second embodiment of a composite headset of the present disclosure. As shown in the two figures, a basic structure of this embodiment is identical with that of the first embodiment, and therefore the same technical features are not repeated herein. A difference of this embodiment lies in that, the thin-film sound production element 14 is disposed in the casing 11 at a side of the sound output surface 12 that faces away from the head of the user. Therefore, the thin-film sound production element 14 and the moving-coil unit 13 of this embodiment are disposed together inside the casing 11.

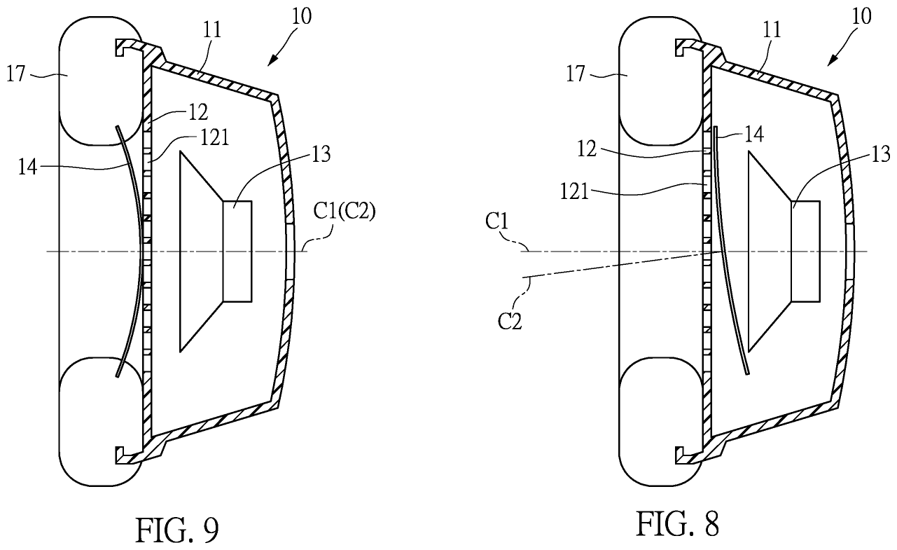

FIG. 8 shows a third embodiment of a composite headset 1 of the present disclosure. As shown in FIG. 8, a difference between this embodiment and the foregoing embodiments lies in that, the thin-film sound production element 14 is slantingly disposed. In this way, a central axial line C2 of a sound field output by the thin-film sound production element 14 is not parallel to a central axial line C1 of a sound field output by the moving-coil unit 13, and thus the sound fields output by the thin-film sound production element 14 and the moving-coil unit 13 are transmitted to the ears of the user along axial lines in different directions.

FIG. 9 shows a fourth embodiment of a composite headset 1 of the present disclosure. As shown in FIG. 9, the sound production module 10 of this embodiment includes a casing 11, a moving-coil unit 13, and a thin-film sound production element 14. A side of the casing 11 that faces the head of the user is provided with a sound output surface 12, and a plurality of sound apertures 121 is provided in the sound output surface 12. The thin-film sound production element 14 is an arc-shaped concave sheet that is formed by being bent towards a sound output direction of the moving-coil unit 13. In this embodiment, the thin-film sound production element 14 is disposed on the casing 11 of the sound production module 10 at a side of the sound output surface 12 that faces the head of the user. The middle concave portion of the thin-film sound production element 14 is close to the sound output surface 12. Two sides of the thin-film sound production element 14 are curved towards the sound output direction of the moving-coil unit 13, so that the sound production surface of the thin-film sound production element 14 forms an arc-shaped concave surface curved towards the sound output direction of the moving-coil unit 13.

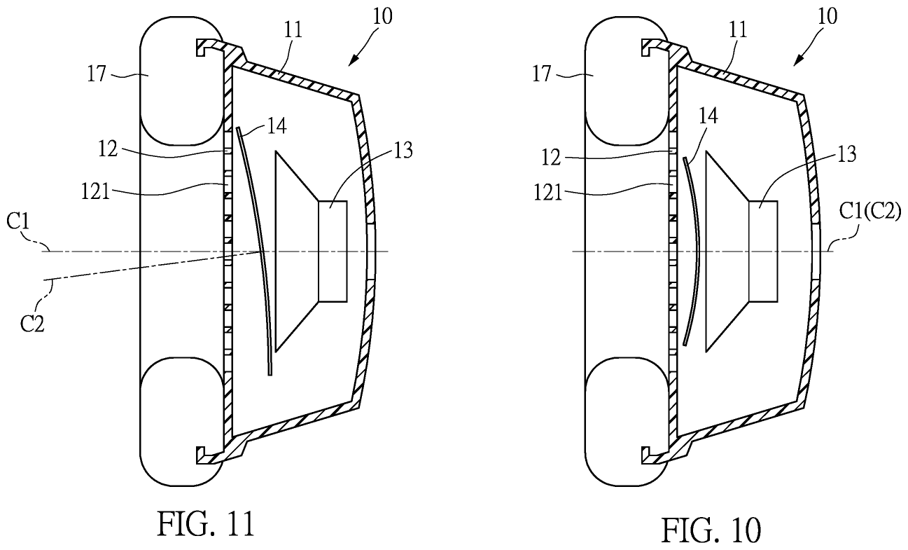

FIG. 10 shows a fifth embodiment of a multi-frequency headset of the present disclosure. As shown in FIG. 10, a difference of this embodiment lies in that, the thin-film sound production element 14 is disposed in the casing 11 at a side of the sound output surface 12 that faces away from the head of the user. Therefore, the thin-film sound production element 14 and the moving-coil unit 13 of this embodiment are disposed together inside the casing 11. Two sides of the thin-film sound production element 14 are curved towards the sound output direction of the moving-coil unit 13, so that the sound production surface of the thin-film sound production element 14 forms an arc-shaped concave surface curved towards the sound output direction of the moving-coil unit 13.

FIG. 11 shows a sixth embodiment of a multi-frequency headset of the present disclosure. As shown in FIG. 11, two sides of the thin-film sound production element 14 are curved towards the sound output direction of the moving-coil unit 13, so that the sound production surface of the thin-film sound production element 14 forms an arc-shaped concave surface curved towards the sound output direction of the moving-coil unit 13. A difference between this embodiment and the foregoing embodiments lies in that, the thin-film sound production element 14 is slantingly disposed. In this way, a central axial line C2 of a sound field output by the thin-film sound production element 14 is not parallel to a central axial line C1 of a sound field output by the moving-coil unit 13, and thus the sound fields output by the thin-film sound production element 14 and the moving-coil unit 13 are transmitted to the ears of the user along axial lines in different directions.

### Possible Effects of the Embodiments

To sum up, the present disclosure achieves the following advantageous effects: The composite headset can improve on the quality of high-frequency sound, and produce a sound field that shapes a sense of space and has rich sound levels, thus improving the sound quality and user experience in listening.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A composite headset, comprising:
two sound production modules, capable of being worn on both sides of the head of a user, and each comprising a moving-coil unit and a thin-film sound production element, wherein
the moving-coil unit is used to produce a first-frequency sound field, the thin-film sound production element is used to produce a second-frequency sound field, the first-frequency sound field and the second-frequency sound field respectively cover different audio frequency ranges; and the thin-film sound production element is an arc-shaped convex sheet that is formed by being bent towards a sound output direction of the moving-coil unit.

2. The composite headset of claim 1, wherein the thin-film sound production element is provided with a piezoelectric thin film and two conductive layers; the two conductive layers are respectively attached to two opposite sides of the piezoelectric thin film, and are electrically connected to a sound source signal, so that a voltage of the sound source signal is transmitted to the two conductive layers to make the piezoelectric thin film vibrate under an inverse piezoelectric effect, so as to produce sound.

3. The composite headset of claim 2, wherein the piezoelectric thin film is made from one or a combination of the following selected materials: polyvinylidene fluoride (PVDF), nylon, polyester, and polyvinyl chloride; and
the two conductive layers are made from one or a combination of the following selected materials: copper (Cu), silver (Ag), chromium (Cr), nickel (Ni), titanium (Ti), titanium nitride (TiN), stannic oxide (SnO₂), indium oxide (In₂O₃), zinc oxide (ZnO), and indium tin oxide (ITO).

4. The composite headset of claim 3, wherein each of the sound production modules is provided with a casing which has a sound output surface, the moving-coil unit is disposed at a side of the sound output surface that faces away from the head of the user, and a sound field produced by the moving-coil unit passes through the sound output surface, and the thin-film sound production element is disposed on the casing at a side of the sound output surface that faces the head of the user.

5. The composite headset of claim 4, wherein a central axial line of the sound field output by the thin-film sound production element is parallel to a central axial line of the sound field output by the moving-coil unit, and a middle convex portion of the thin-film sound production element keeps a distance from the sound output surface.

6. The composite headset of claim 3, wherein each of the sound production modules is provided with a casing which has a sound output surface, the moving-coil unit is disposed at a side of the sound output surface that faces away from the head of the user, and a sound field produced by the moving-coil unit passes through the sound output surface, and the thin-film sound production element is disposed in the casing at a side of the sound output surface that faces away from the head of the user.

7. The composite headset of claim 6, wherein a central axial line of the sound field output by the thin-film sound production element is parallel to a central axial line of the sound field output by the moving-coil unit.

8. The composite headset of claim 6, wherein a central axial line of the sound field output by the thin-film sound production element is not parallel to a central axial line of the sound field output by the moving-coil unit.

9. A composite headset, comprising:
two sound production modules, capable of being worn on both sides of the head of a user, and each comprising a moving-coil unit and a thin-film sound production element, wherein
the moving-coil unit is used to produce a first-frequency sound field, the thin-film sound production element is used to produce a second-frequency sound field, the first-frequency sound field and the second-frequency sound field respectively cover different audio frequency ranges; and the thin-film sound production element is an arc-shaped concave sheet that is formed by being bent towards a sound output direction of the moving-coil unit.

10. The composite headset of claim 9, wherein the thin-film sound production element is provided with a piezoelectric thin film and two conductive layers; the two conductive layers are respectively attached to two opposite sides of the piezoelectric thin film, and are electrically connected to a sound source signal, so that a voltage of the sound source signal is transmitted to the two conductive layers to make the piezoelectric thin film vibrate under an inverse piezoelectric effect, so as to produce sound.

11. The composite headset of claim 10, wherein each of the sound production modules is provided with a casing which has a sound output surface; the moving-coil unit is disposed at a side of the sound output surface that faces away from the head of the user, and a sound field produced by the moving-coil unit passes through the sound output surface; and the thin-film sound production element is disposed on the casing at a side of the sound output surface that faces the head of the user.

12. The composite headset of claim 11, wherein a central axial line of the sound field output by the thin-film sound production element is parallel to a central axial line of the sound field output by the moving-coil unit, and a middle concave portion of the thin-film sound production element keeps a distance from the sound output surface.

13. The composite headset of claim 10, wherein each of the sound production modules is provided with a casing which has a sound output surface; the moving-coil unit is disposed at a side of the sound output surface that faces away from the head of the user, and a sound field produced by the moving-coil unit passes through the sound output surface; and the thin-film sound production element is disposed in the casing at a side of the sound output surface that faces away from the head of the user.

14. The composite headset of claim 13, wherein a central axial line of the sound field output by the thin-film sound production element is parallel to a central axial line of the sound field output by the moving-coil unit.

15. The composite headset of claim 13, wherein a central axial line of the sound field output by the thin-film sound production element is not parallel to a central axial line of the sound field output by the moving-coil unit.
